(19) United States
(12) Patent Application Publication
(10) Pub. No.: US 2016/0089996 A1
(43) Pub. Date: Mar. 31, 2016

(54) CHARGING STAND

(71) Applicant: CHUO HATSUJO KABUSHIKI KAISHA, Nagoya-shi (JP)

(72) Inventor: Akehito Sugiura, Nagoya-shi (JP)

(21) Appl. No.: 14/851,659

(22) Filed: Sep. 11, 2015

(30) Foreign Application Priority Data
Sep. 26, 2014 (JP) 2014-196199

(51) Int. Cl. B60L 11/18

(52) U.S. Cl. CPC B60L 11/1818; B60L 11/1824

(57) ABSTRACT

A charging stand includes a charging cable detachably attachable to an electrically-driven vehicle; a winding mechanism configured to wind the charging cable; a housing configured to house the winding mechanism; and a winding length changing mechanism configured to change and adjust a windable length of the charging cable to be wound by the winding mechanism.

### CROSS-REFERENCE TO RELATED APPLICATIONS

This application claims the benefit of Japanese Patent Application No. 2014-196199 filed Sep. 26, 2014 in the Japan Patent Office, the entire disclosure of which is incorporated herein by reference.

### BACKGROUND

The present disclosure relates to a charging stand that houses a charging cable for an electrically-driven vehicle. The electrically-driven vehicle means a vehicle having an electric motor for traveling. The electrically-driven vehicle includes, for example, an electric vehicle having only an electric motor as a driving source, a plug-in hybrid vehicle having an electric motor and an internal combustion engine as driving sources, and the like.

For example, in a charging stand described in Japanese Unexamined Patent Application Publication No. 2014-033576, a winding mechanism for winding a charging cable is housed in a housing. Once the winding mechanism starts winding of the charging cable, the charging cable in its entirety is to be pulled into the housing unless a user manually stops an operation of the winding mechanism.

### SUMMARY

There may be some users who do not want “an entire charging cable that has been pulled out to be pulled into the housing”. Such users need to manually stop the operation of the winding mechanism at each time of winding the charging cable. Accordingly, the users may regard housing operation of the charging cable as troublesome.

A charging stand in one aspect of the present disclosure comprises: a charging cable detachably attachable to an electrically-driven vehicle; a winding mechanism configured to wind the charging cable; a housing configured to house the winding mechanism; and a winding length changing mechanism configured to change and adjust a windable length of the charging cable to be wound by the winding mechanism.

According to the present disclosure, it is possible to change and adjust a windable length of the charging cable to be wound by the winding mechanism. Thus, it is possible to achieve an improved efficiency in housing operation of the charging cable.

### BRIEF DESCRIPTION OF THE DRAWINGS

Hereinafter, preferred embodiments of the present disclosure will be described with reference to the accompanying drawings, in which:

FIG. 1 is an overall view showing a configuration of a charging stand according to a first embodiment;

FIG. 2 is a right side elevation view of FIG. 1;

FIG. 3A and FIG. 3B are explanatory views of an operation of a cable retention mechanism;

FIG. 4 is an enlarged view of a winding length changing mechanism according to the first embodiment;

FIG. 5 is an overall view showing a configuration of a charging stand according to a second embodiment;

FIG. 6A and FIG. 6B are overall views showing a configuration of a charging stand according to a third embodiment;

FIG. 7 is an enlarged view of a winding length changing mechanism according to a fourth embodiment;

FIG. 8 is an enlarged view of a winding length changing mechanism according to the fourth embodiment;

FIG. 9 an enlarged view of a winding length changing mechanism according to the fourth embodiment; and

FIG. 10 is an enlarged view of a winding length changing mechanism according to the fourth embodiment.

### DETAILED DESCRIPTION OF THE PREFERRED EMBODIMENTS

Embodiments described hereinafter are illustrative only. Matters, including the invention specifying matters, recited in the claims are not limited to specific means, structures, or the like shown in the embodiments below.

Each of the present embodiments is an example of a charging stand housing a charging cable for a plug-in hybrid vehicle (hereinafter referred to as an “electrically-driven vehicle”). Arrows indicating directions, or the like in the figures are provided for better understanding of the relationships among the figures, and are not intended to limit the scope of the present disclosure.

At least each member or portion described with an assigned reference numeral is provided in a number of at least one, except when a specific reference, such as “a plurality of” and “two or more”, is made.

### First Embodiment

1. Overview of Charging Stand

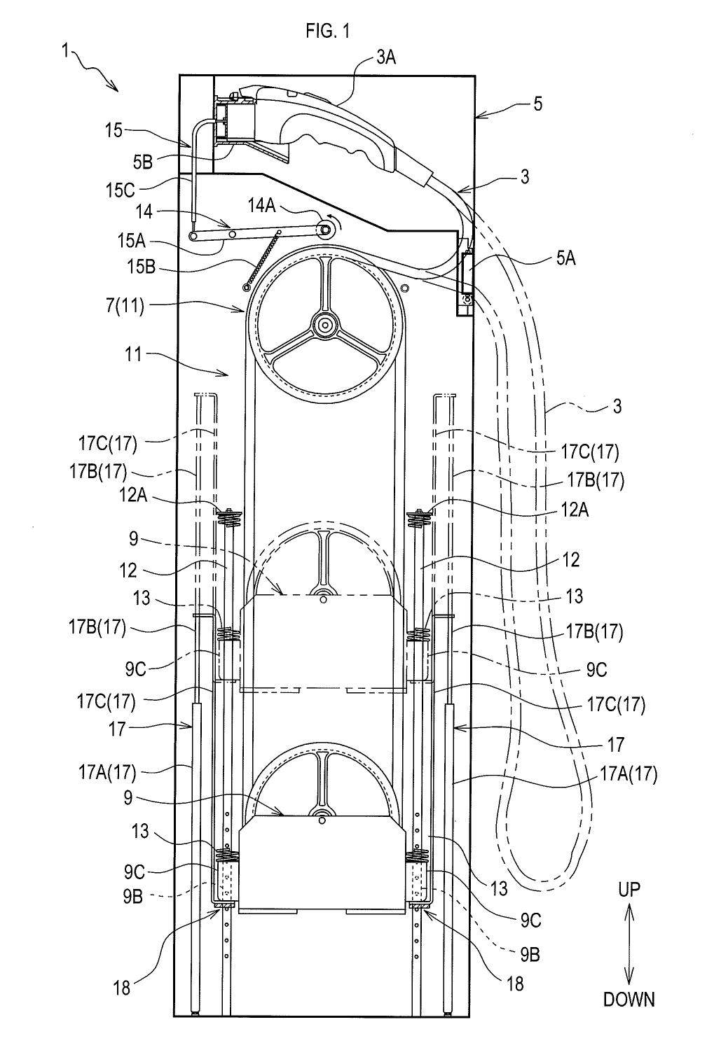

As shown in FIG. 1, a charging stand 1 comprises a housing 5, a winding mechanism 11, and other components. A charging cable 3 is a cable having flexibility and configured to electrically connect a power source for charging (not shown) and an electrically-driven vehicle.

At one longitudinal end of the charging cable 3 is provided a plug portion 3A to connect the charging cable 3 to an electrically-driven vehicle. The plug portion 3A is a connection that is detachably attachable to an electrically-driven vehicle. The other longitudinal end of the charging cable 3 is connected to the power source.

The housing 5 is a storage container to store the charging cable 3. The housing 5 is formed, for example, by shaping a metal sheet of SPCC (cold rolled steel) or the like into a cylindrical shape (a square cylindrical shape in the present embodiment). The housing 5 is installed such that a longitudinal direction of the housing 5 is the same as the vertical direction.

The housing 5 is provided with a port 5A through which the charging cable 3 passes. The port 5A is located at a vertically upper part of the housing 5 and is opened in a horizontal direction. Vertically above the port 5A in the housing 5A is provided a plug placement portion 5B.

The plug placement portion 5B is a cylindrical portion into which a leading end of the plug portion 3A is inserted. A winding mechanism 11 to wind the charging cable 3 is provided vertically below the plug placement portion 5B in the housing 5.

2. Configuration of Winding Mechanism

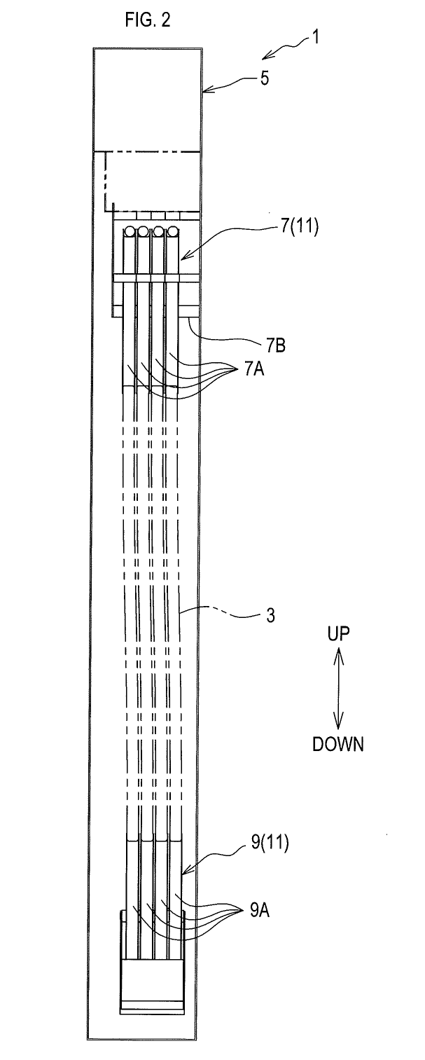

The winding mechanism 11 comprises a stationary pulley portion 7, a movable pulley portion 9, and other components. As shown in FIG. 2, the stationary pulley portion 7 and the movable pulley portion 9 are arranged in the housing 5. The stationary pulley portion 7 comprises at least one pulley 7A, whereas the movable pulley portion 9 comprises at least one pulley 9A. The at least one pulley 7A and the at least one pulley 9A each have a disk-like shape, and the charging cable 3 is wound around the at least one pulley 7A and the at least one pulley 9A.

Specifically, the stationary pulley portion 7 comprises a plurality of (four in the present embodiment) pulleys 7A. Each of the plurality of pulleys 7A is supported by a shaft 7B that is fixed to the housing 5 so as to be rotatable with respect to the shaft 7B. Consequently, the plurality of pulleys 7A are rotatable in accordance with a movement of the charging cable 3, without moving with respect to the housing 5.

The movable pulley portion 9 comprises a plurality of (four in the present embodiment) pulleys 9A. The plurality of pulleys 9A can collectively move in a receding manner or in an approaching manner with respect to the stationary pulley portion 7. Also, the plurality of pulleys 9A are each rotatable. The charging cable 3 is wound around the stationary pulley portion 7 and the movable pulley portion 9 in a state where the movable pulley portion 9 is located below the stationary pulley portion 7.

As shown in FIG. 1, the charging cable 3 extends vertically downward from its fixed end that is fixed to the stationary pulley portion 7; then, its extending direction is changed upward by the movable pulley portion 9, and the charging cable 3 returns to the stationary pulley portion 7. Accordingly, when the charging cable 3 is pulled out of the housing 5, the movable pulley portion 9 is shifted upward in proportion to a pulled out length of the charging cable 3.

A force to shift the movable pulley portion 9 downward is always exerted on the movable pulley portion 9 due to gravity acting on the movable pulley portion 9. When the movable pulley portion 9 is shifted downward, the charging cable 3 is pulled into the housing 5 in proportion to an amount of the shift. That is to say, the movable pulley portion 9 functions as a movable portion that operates in accordance with the movement (pulling in and pulling out) of the charging cable 3.

A pair of (two) guide members 12 guide the movable pulley portion 9.

Each of the guide members 12 is provided on horizontally either side of the movable pulley portion 9. In other words, the two guide members 12 are provided on respective sides, with the movable pulley portion 9 located therebetween, in a horizontal direction perpendicular to rotation axes of the plurality of pulleys 9A.

Each of the two guide members 12 is a rod-like member extending vertically. A guided portion 9C corresponding to each of the guide members 12 is provided to the movable pulley portion 9; that is, there are total two guided portions 9C. Each of the two guided portions 9C has a guide hole 9B. Each of the guide members 12 passes through the corresponding guide hole 9B.

An inner circumferential surface of each of the two guide holes 9B slidingly contacts with the corresponding one of the two guide members 12, with the result that the movable pulley portion 9 is guided by the two guide members 12. At an upper end of each of the two guide members 12A is provided an umbrella-shaped stopper portion 12A.

A coil spring 13 is arranged between the stopper portion 12A and the corresponding guided portion 9C. Specifically, the coil spring 13 is arranged between one of the two stopper portions 12A and the corresponding one of the two guided portions 9C. When the movable pulley portion 9 is shifted, the two coil springs 13 are shifted along with the movable pulley portion 9. A natural length of the coil spring 13 is set such that, when a distance between the movable pulley portion 9 and the stationary pulley portion 7 reaches a previously set distance (hereinafter referred to as a “set distance”), an upper end of the coil spring 13 contacts the corresponding stopper portion 12A. This setting applies to both of the two coil springs 13.

When the distance between the movable pulley portion 9 and the stationary pulley portion 7 becomes shorter than the set distance, the two coil springs 13 are compressed and deformed. Accordingly, in a state where the movable pulley portion 9 becomes closest to the stationary pulley portion 7, that is, in a state where the charging cable 3 is pulled out most, the two coil springs 13 exert forces on the movable pulley portion 9 so as to shift the movable pulley portion 9 downward.

3. Speed Control Mechanism

A speed control mechanism 17 is a mechanism to control an operation speed of a movable portion, such as the movable pulley portion 9, so as not to exceed a preset speed; the speed control mechanism 17 at least operates when the charging cable 3 is wound by the winding mechanism 11. Although a pair of (two) speed control mechanisms 17 are provided, a description will be given here of only one of the speed control mechanisms 17.

Specifically, the speed control mechanism 17 is a viscous damper mechanism that comprises a tubular cylinder 17A, a rod 17B that slidingly moves along the cylinder 17A, and a coupling member 17C that couples the rod 17B with the movable pulley portion 9.

A viscous fluid, such as oil, is encapsulated in the cylinder 17A. At a cylinder 17A side end of the rod 17B is provided a piston (not shown) that divides an interior space of the cylinder 17A into two subspaces and also slidingly contacts an inner wall of the cylinder 17A.

The piston is provided with at least two communication paths (not shown) to allow communication between the two subspaces. In one communication path having a smaller pressure loss (flow resistance) of the at least two communication paths is arranged a one-way valve (not shown) that allows the viscous fluid to flow therethrough in only one direction.

The one-way valve opens the one communication path to allow the viscous fluid to flow therethrough when the rod 17B comes out from the cylinder 17A, whereas the one-way valve closes the one communication path to inhibit the viscous fluid from flowing therethrough when the rod 17B enters the cylinder 17A.

Consequently, the pressure loss generated when the rod 17B comes out from the cylinder 17A is smaller, whereas the pressure loss generated when the rod 17B enters the cylinder 17A is larger. That is to say, the speed control mechanism 17 functions as a damper to reduce increase in shifting speed of the movable pulley portion 9 when the charging cable 3 is wound.

4. Cable Retention Mechanism

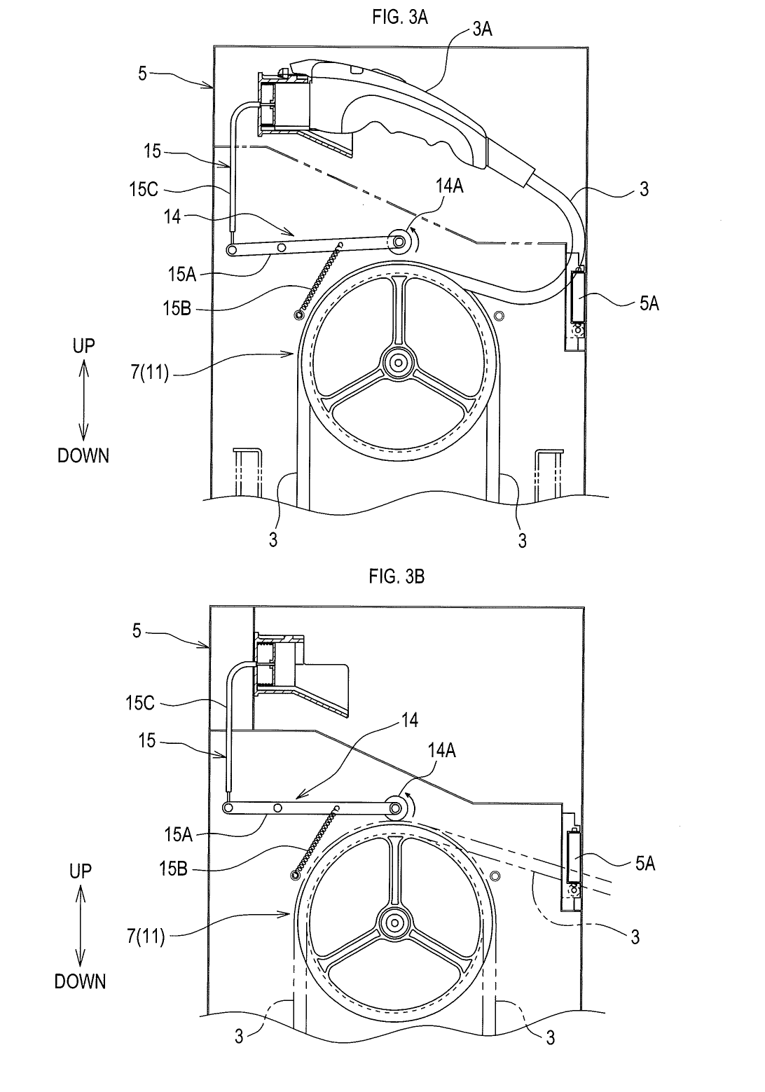

A cable retention mechanism 14 at least serves a function to prevent the charging cable 3 from being pulled into the housing 5. Specifically, as shown in FIG. 3A and FIG. 3B, the cable retention mechanism 14 comprises an abutment member 14A and an attachment/detachment interlocking mechanism 15.

The abutment member 14A is configured to be capable of contacting the charging cable 3 and separating from the charging cable 3. For example, the abutment member 14A can contact a part of the charging cable 3, the part contacting the stationary pulley portion 7 (see FIG. 3B). When contacting the charging cable 3, the abutment member 14A presses the charging cable 3 against the stationary pulley portion 7 (see FIG. 3B).

The abutment member 14A comprises a rotation body (a roller) that is rotatable only in a direction corresponding to pulling out of the charging cable 3. The roller comprised in the abutment member 14A (in other words, the roller forming the abutment member 14A) is rotatably supported via a one-way clutch (not shown) that allows rotation only in one direction. Accordingly, while the abutment member 14A contacts the charging cable 3, the charging cable 3 is prevented from being pulling into the housing 5, whereas the charging cable 3 is allowed to be pulled out from the housing 5.

The attachment/detachment interlocking mechanism 15 is a mechanism that causes the abutment member 14A to separate from the charging cable 3 or to contact the charging cable 3 depending on whether or not the plug portion 3A is placed on the plug placement portion 5B. The attachment/detachment interlocking mechanism 15 comprises an arm member 15A, a spring 15B, an interlocking member 15C, and other components.

The arm member 15A is an arm-shaped member that is swingably assembled to the housing 5. The abutment member 14A is assembled to an end of the arm member 15A. The spring 15B is an elastic member that applies elastic force to the arm member 15A. The abutment member 14A is pressed against the charging cable 3 by the elastic force of the spring 15B.

The interlocking member 15C is shifted by being mechanically interlocked with attachment and detachment of the plug portion 3A to and from the plug placement portion 5B, and thereby transmits the shift to the arm member 15A. The interlocking member 15C is configured with a push-pull wire that is capable of transmitting pushing force and pulling force.

5. Winding Length Changing Mechanism

As shown in FIG. 1, two winding length changing mechanisms 18 are provided. The two winding length changing mechanism 18 are mechanisms located in a lower portion of the housing 5 and configured to change or adjust a windable length of the charging cable 3 to be wound by the winding mechanism 11.

The “windable length of the charging cable 3” means, for example, “a length of a part of a cord portion of the charging cable 3 that is not housed in the housing 5 in a state where winding of the charging cable 3 by the winding mechanism 11 is stopped”.

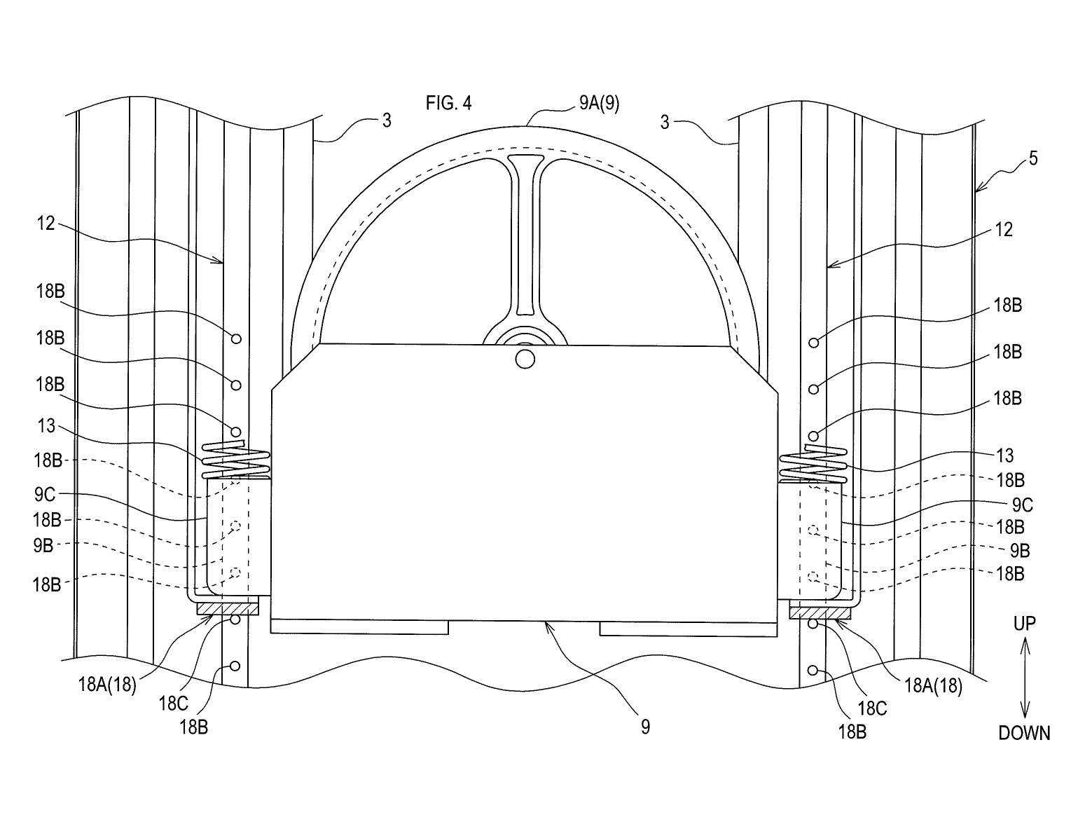

As shown in FIG. 4, each of the two winding length changing mechanisms 18 comprises a stopper 18A that is contactable with the movable pulley portion 9. When contacting the movable pulley portion 9, the stopper 18A prevents the movable pulley portion 9 from moving in a direction corresponding to winding of the charging cable 3, i.e., moving downward.

The stopper 18A is assembled to the guide member 12. Each of the two guide members 12 has a plurality of recesses or through holes (a plurality of through holes 18B in the present embodiment) arranged separately from one another in a longitudinal direction of the guide member 12. A lock member 18C is detachably attachable to any one of the plurality of through holes 18B. Specifically, each lock member 18C is attachable to an optional one of the plurality of through holes 18B. The lock member 18C may be a pin, or the like.

The stopper 18A is provided with a through hole (not shown) through which the corresponding guide member 12 passes. The through hole provided to each of the two stoppers 18A is configured to have a dimension larger than an outer dimension of the guide member 12.

Accordingly, each of the two stoppers 18A is locked by the corresponding lock member 18C at a position of the optional one of the plurality of through holes 18B to which the lock member 18C is attached. Thus, respective positions of the two stoppers 18A are set. When the movable pulley portion 9 is shifted downward, the movable pulley portion 9 hits the two stoppers 18A, and thereby a lower-side position of the movable pulley portion 9 is restricted by the two stoppers 18A. Consequently, the “windable length of the charging cable 3” varies depending on positions of the two stoppers 18A, and thus on attached positions of the two lock members 18C.

6. Features of Charging Stand of Present Embodiment

It is possible to change and adjust the windable length of the charging cable 3 by changing the positions of the two stoppers 18A and thus the attached positions of the two lock members 18C. It is, therefore, possible to achieve an improved efficiency in housing operation of the charging cable 3.

### Second Embodiment

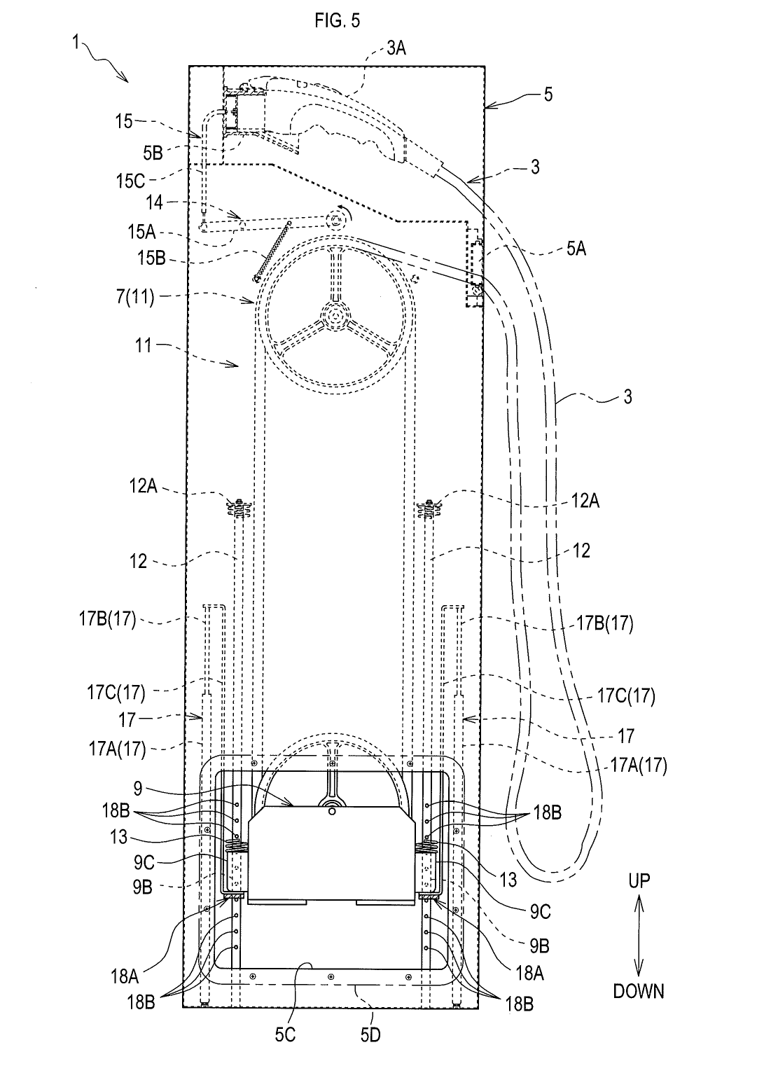

In a second embodiment, as shown in FIG. 5, an opening 5C is provided in a part of the housing 5 corresponding to a region where the two winding length changing mechanisms 18 (the two stoppers 18A) are located. The charging stand 1 is also provided with a lid 5D to close the opening 5C. The lid 5D is detachably assembled to the housing 5 by means of fasteners, such as screws.

According to the present embodiment, in which the opening SC is provided, it is possible to change the respective positions of the two stoppers 18A without disassembling the housing 5.

### Third Embodiment

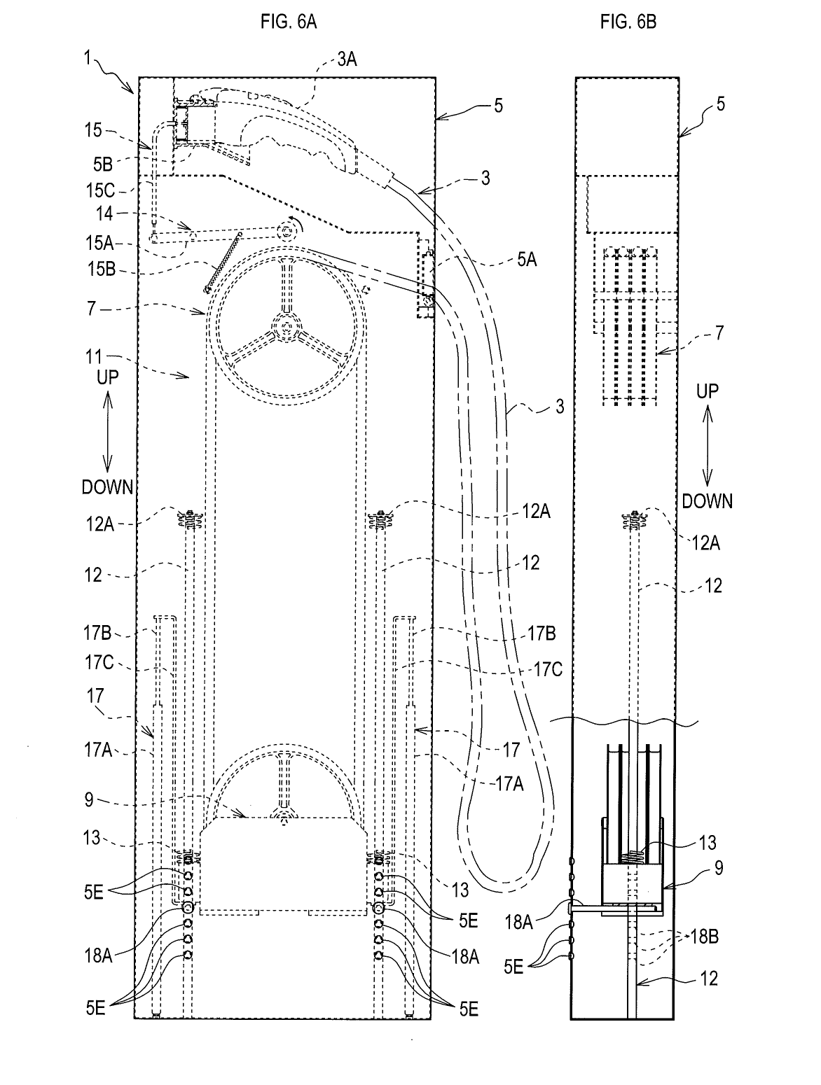

In a third embodiment, as shown in FIG. 6A and FIG. 6B, a part of the housing 5 corresponding to the plurality of through holes 18B comprises a plurality of insertion holes SE into which at least one pin-shaped stopper 18A (for example, the two stoppers 18A) can be inserted. In each of one or more of the insertion holes SE into which the at least one stopper 18A is not inserted, a plug made of elastic material, such as rubber, may be fitted.

According to the third embodiment, as shown in FIG. 6B, it is possible to detachably attach the at least one stopper 18A to optional at least one of the through holes 18B externally from the housing 5. Although the at least one pin-shaped stopper 18A is used instead of the lock member 18C in the third embodiment, the third embodiment is not limited to such configuration. In the same manner as in the above described first and second embodiments, two stoppers 18A and two lock members 18C may be provided such that setting of the positions of the two stoppers 18A is performed by the two lock members 18C.

### Fourth Embodiment

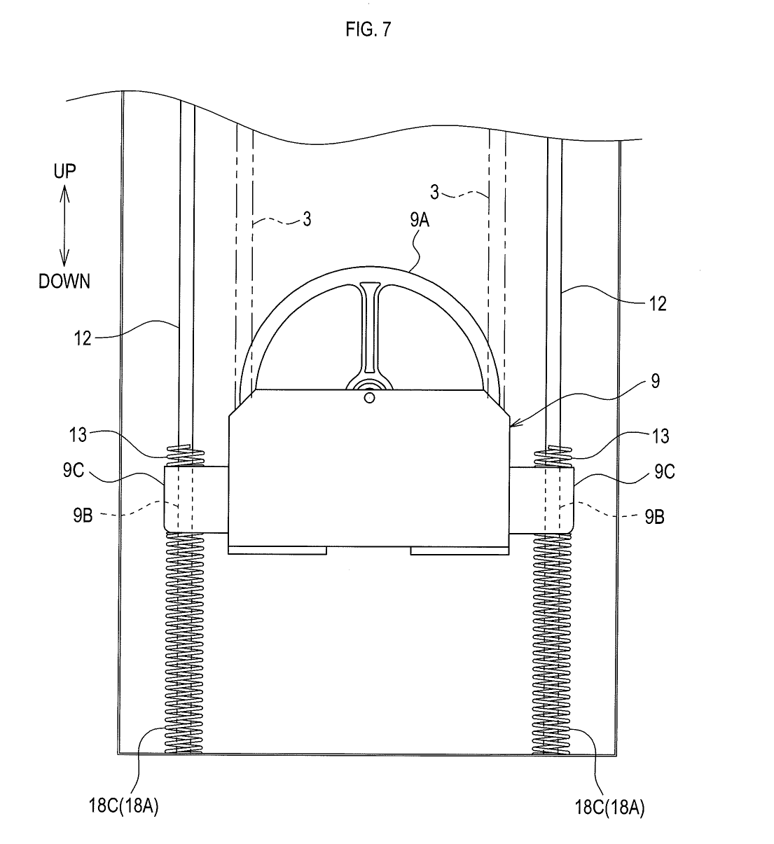

In a fourth embodiment, the speed control mechanism 17 comprises two stoppers 18A as shown in FIG. 7 to FIG. 10. The two stoppers 18A each comprise an elastically deformable elastic body.

The two stoppers 18A (the two elastic bodies 18C) are arranged at a bottom of the housing 5, and are elastically deformable at least in a direction of operation of the movable pulley portion 9 (i.e., in the vertical direction). A movable pulley portion 9 side end of each of the two elastic bodies 18C contacts the movable pulley portion 9.

In the fourth embodiment, it is necessary to change a dimension in a direction of elastic deformation (that is, a dimension in an up-down direction) of the two elastic bodies 18C (two stoppers 18A), in order to change or adjust the windable length of the charging cable 3. For example, it is possible to change or adjust the windable length of the charging cable 3 by employing another elastic body 18C (stopper 18A) having a different up-down direction dimension.

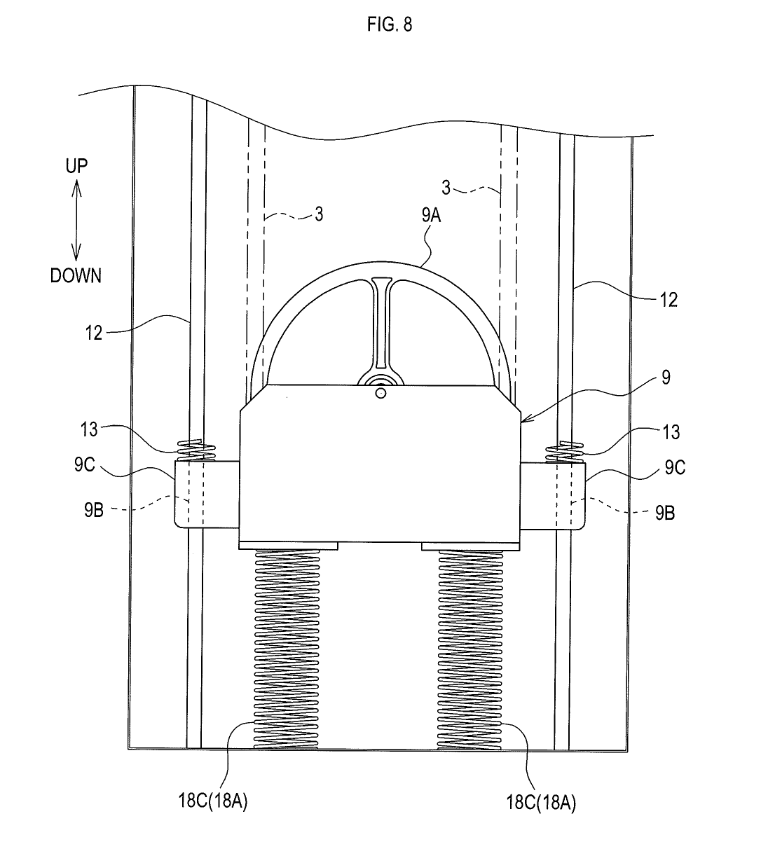

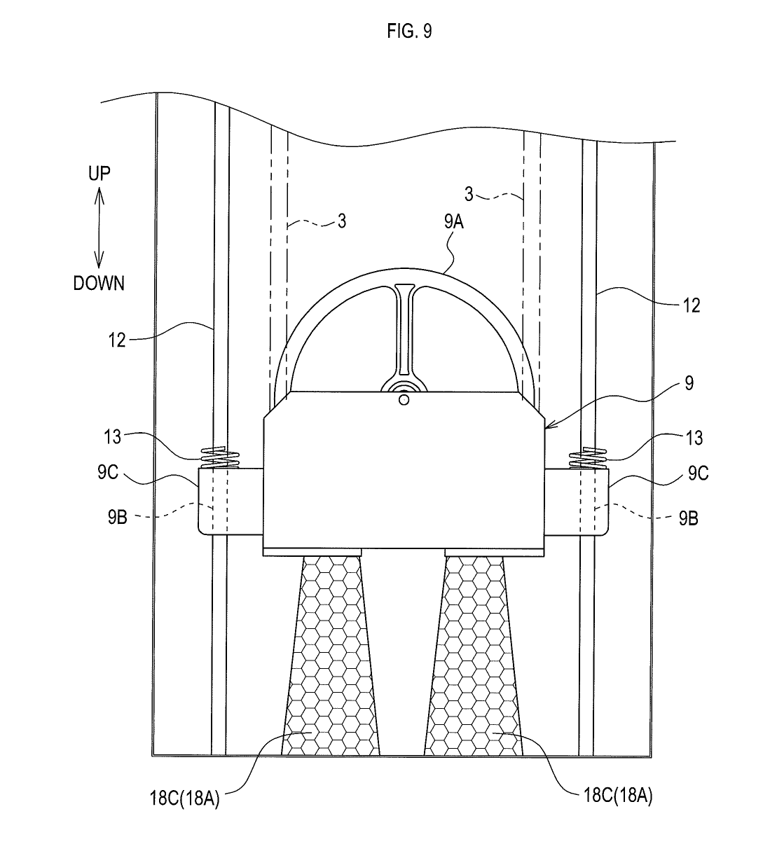

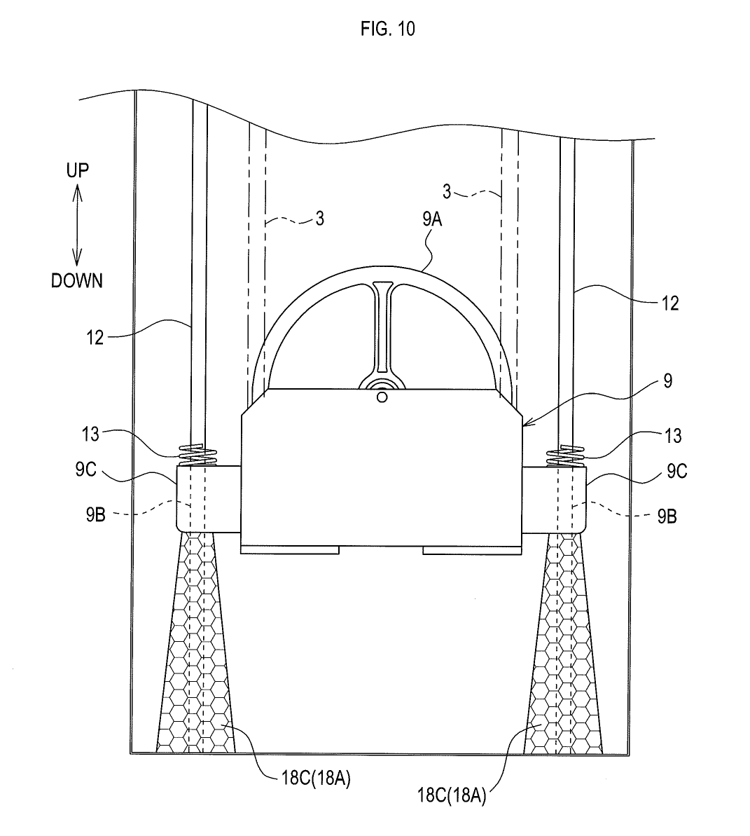

FIG. 7 and FIG. 8 show examples in which each of the two elastic bodies 18C is configured with a coil spring. FIG. 9 and FIG. 10 show examples in which each of the two elastic bodies 18C is made of rubber. In FIG. 7 and FIG. 10, each of the two elastic bodies 18C contacts the corresponding one of the two guided portions 9C of the movable pulley portion 9. In FIG. 8 and FIG. 9, each of the two elastic bodies 18C contacts a lower end of the movable pulley portion 9.

### Other Embodiments

The winding length changing mechanism 18 is not limited to the configurations shown in the above described embodiments. For example, a configuration may be employed in which a coupling position between the rod 17B and the coupling member 17C is variable. Also, a configuration may be employed in which the cord portion of the charging cable 3 is provided with at least one stopper 18A, and the at least one stopper 18A is configured to be locked at a periphery of the port 5A.

Although the speed control mechanism 17 and the cable retention mechanism 14 is provided in each of the above described embodiments, the present disclosure is not limited to the configuration; at least one of the speed control mechanism 17 and the cable retention mechanism 14 may be omitted.

Although the winding mechanism 11 comprises the stationary pulley portion 7 and the movable pulley portion 9 in each of the above described embodiments, the present disclosure is not limited to the configuration; for example, a configuration may be employed in which the charging cable 3 is wound by an electric motor.

What is claimed is:

1. A charging stand comprising:
a charging cable detachably attachable to an electrically-driven vehicle;
a winding mechanism configured to wind the charging cable;
a housing configured to house the winding mechanism; and
a winding length changing mechanism configured to change and adjust a windable length of the charging cable to be wound by the winding mechanism.

2. The charging stand according to claim 1, wherein the winding length changing mechanism comprises:
at least one stopper configured to be contactable with a movable portion that operates in accordance with a movement of the charging cable and to prevent, when the at least one stopper contacts the movable portion, movement of the movable portion in a direction corresponding to winding of the charging cable.

3. The charging stand according to claim 2, further comprising:
at least one positioning unit configured to define a position of the at least one stopper.
